(19) United States
(12) Patent Application Publication
(10) Pub. No.: US 2004/0007919 A1
(43) Pub. Date: Jan. 15, 2004

(54) Electro-aerodynamic motor for moving vehicles

(76) Inventor: Tanveer Ul Haq, Houston, TX (US)

Correspondence Address: Tanveer Ul Haq, 16230 Brookford Dr., Houston, TX, 77059, US

(21) Appl. No.: 10/192,269

(22) Filed: Jul. 10, 2002

(51) Int. Cl. H02K 1/00

(52) U.S. Cl. 310/10

(57) ABSTRACT

A hybrid motor which can utilize the merits of both electrically driven and Aerodynamic Driven motor which can be used in any moving vehicle such as cars, trucks, tractors, trains, planes, boats, ships etc with out the hazard of combustion of fuel and pollution of the environment by exhaustion. There will be no cooling of engine involve. No use of fuel of any kind is involved.

### BACKGROUND OF INVENTION

This invention relates to a novel type of motor to provide rotary force from an aerodynamic and electrical motor, which does not require any fuel combustion. The input energy is less than the energy it outputs. A running moving fan intakes less input of energy than output if exposed in the air.

### DESCRIPTION

The current technique of moving a motorized machine is either through an internal combustion engine which burns fuel inside a close cylinder which moves the pistons in an engine up and down which turns the crankshaft to move the vehicle, or electrically powered motors run on electricity supplied by batteries, the motor drives the transmission.

A certain number of fans will be mounted on the front and rear of the machine (car) with a directional electronic sensor to point them in the direction at which maximum aerodynamic force can be captured. The fans will be connected to electrical motors powered by battery. A generator (Alternator) will be connected to the fans with belts to charge the battery. The fans will also be connected with belts to the motor, which drives the transmission.

The movement of fans will be initially with electric power supplied by the battery and at all times when aerodynamic force is unavailable. The fans will be exposed to outside air all the time. The movement of fans will move the gears of the transmission, which will drive the axel. Once the vehicle is in motion aerodynamic force will come into play rotating the fans.

The gears will move forward or backward as set or may stay still. The transmission will drive the vehicle. As the vehicle moves and gains momentum the vehicle will utilize aerodynamic power along with electrical power supplied by the battery.

The battery will be restored to its original potential by continuous charging by the fans. High mileage can be attained if conditions are favorable.

The speed will be controlled or limited by the size of the fans, the speed of wind, humidity,the direction of wind, the surroundings, and other natural conditions. The horsepower generated will be directly related to the size of the fans and the rotations per minute they make.

### SUMMARY OF INVENTION

The present invention was made with a view to eliminate fuel consumption in driving a machine, which is expensive and scarce.

Another object of the invention is to capture the aerodynamic energy, which is large supply and is available free of cost.

A further idea is to eliminate the emission into the environment of waste, which has become a health hazard.

This type of motor will reduce the size of the engine and will be light in weight. It will provide advantages that are available in heavy and big engines.

1. A motor, which can be used to run to any kind of machine that moves on rotary driving force, provided by aerodynamic force and electrical power.

2. A motor, which will, eliminates the drawbacks of internal combustion engine such as emission of waste and cooling system.

3. A motor, which can be used on any moving vehicle without the utilization of fuel and burning of energy from any source.

4. A motor, which can attain high speed, without requiring the battery to be recharged or replaced frequently.
